(19) United States
(12) Patent Application Publication
(10) Pub. No.: US 2008/0040353 A1
(43) Pub. Date: Feb. 14, 2008

(54) SYSTEM AND METHOD OF MANUFACTURING MANAGEMENT

(75) Inventors: Yung Cheng CHANG, Tainan (TW); Fan Tien CHENG, Tainan City (TW)

Correspondence Address: HAYNES AND BOONE, LLP, 901 Main Street, Suite 3100, Dallas, TX, 75202, US

(73) Assignee: TAIWAN SEMICONDUCTOR MANUFACTURING COMPANY, LTD., Hsin-Chu (TW)

(21) Appl. No.: 11/463,801

(22) Filed: Aug. 10, 2006

(51) Int. Cl. G06F 17/30

(52) U.S. Cl. 707/10

(57) ABSTRACT

A manufacturing management system comprises a plurality of management modules, where each module operable to perform functions associated with a phase of a manufacturing cycle, a plurality of engineering chain agents associated and communicating with each of the plurality of management modules and operable to perform specific functions related to data exchange between the plurality of management modules, and a plurality of web service interface modules enabling the plurality of engineering chain agents to communicate with one another and exchange data across a computer network.

### BACKGROUND

In the current semiconductor industry, the development of a new device often involves multiple un-related parties, including non-integrated device manufacturers (non-IDM) such as fabless design houses, intellectual property library providers, foundry service providers, mask service providers and assembly/test houses, and finally the device manufacturer itself that will produce the devices. Therefore, throughout the device design, verification, and test engineering cycle, a large volume of data must be exchanged between these parties. With increasing complexity of device design and density, ever smaller device feature sizes, and shortened time-to-market design cycle, the lack of a proper framework to manage information sharing among these multiple parties has led to a low success rate for the first-time design-to-production release of most devices. This problem translates to higher cost, lost revenue and delayed time-to-market.

### BRIEF DESCRIPTION OF THE DRAWINGS

Aspects of the present disclosure are best understood from the following detailed description when read with the accompanying figures. It is emphasized that various features are not necessarily drawn to scale. In fact, the dimensions of the various features may be arbitrarily increased or reduced for clarity of discussion.

FIG. 1 is a simplified block diagram of an embodiment of a system for engineering chain management;

FIG. 2 is a more detailed block diagram of an embodiment of a system for engineering chain management;

FIG. 3 is a simplified block diagram of an embodiment of an engineering chain agent; and

FIG. 4 is a data sequence flow diagram of an embodiment of a system and method for engineering chain management.

### DETAILED DESCRIPTION

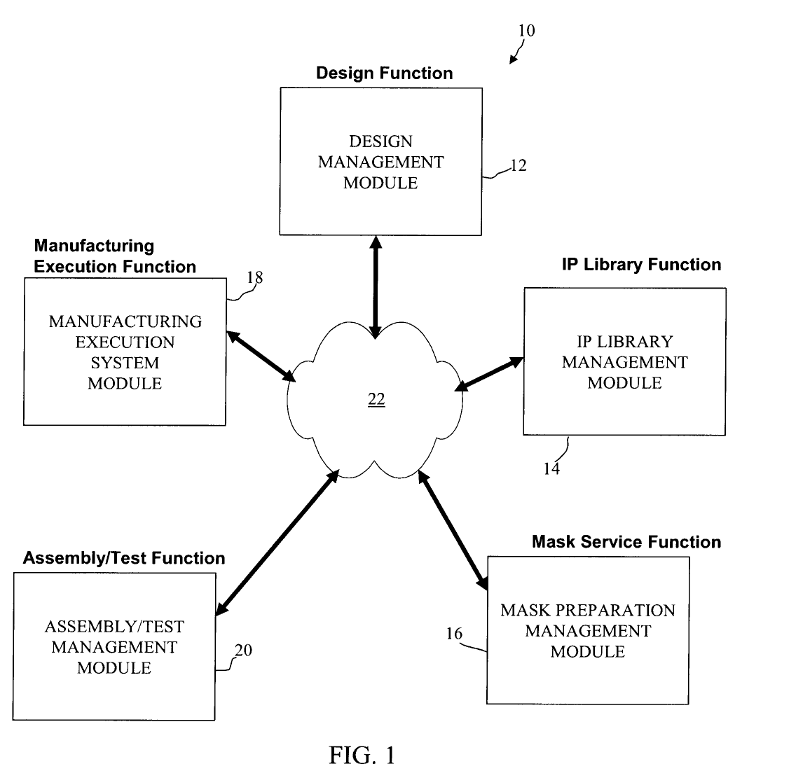

FIG. 1 is a simplified block diagram of an embodiment of a system 10 for engineering chain management or manufacturing management. Engineering chain management system 10 may be used in the design, development and manufacturing cycle of any product not limited to semiconductor devices. System 10 may include a plurality of management modules including a design function 12 intended to be used by a design house, design facility, or any forms of design operation. System 10 may also include an intellectual property (IP) library function 14 intended to be used by a service provider of proven design building blocks that may be incorporated into new product designs. System 10 also may include a mask preparation function 16 that is intended to be used by a semiconductor mask service provider. System 10 may include a manufacturing execution function 18 to be used by a manufacturer of the product. An assembly/test function 20 is also provided to an assembly and test service provider. All system modules may communicate electronically with one another via a network 22 which may be a global network such as the World Wide Web and the Internet. The data may also be communicated wirelessly. Each module 12-20 comprises a web service interface component that is operable to convert data in diverse formats into one or more web service message formats for transmission across network 22 to one or more other modules using one or more transport protocols. System 10 may use web service formats and protocols now known, such as XML (extensible Markup Language), SOAP (Simple Object Access Protocol), WSDL (Web Services Description Language), UDDI (Universal Description, Discovery and Integration), HTTPR (Reliable HyperText Transport Protocol), or web service formats and protocols to be developed in the future.

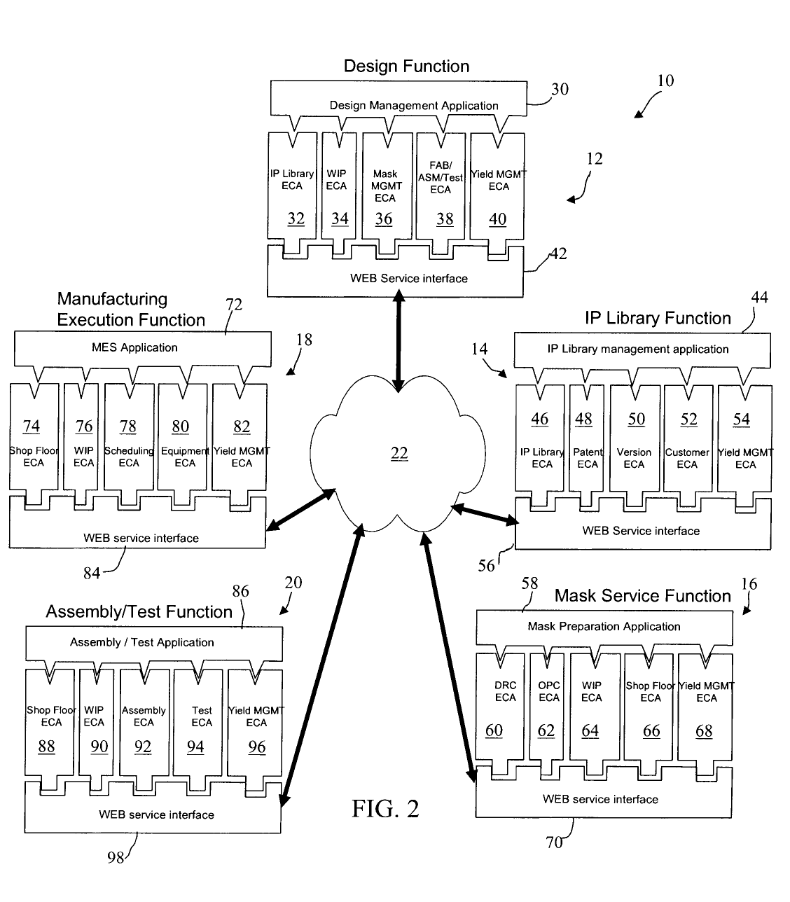

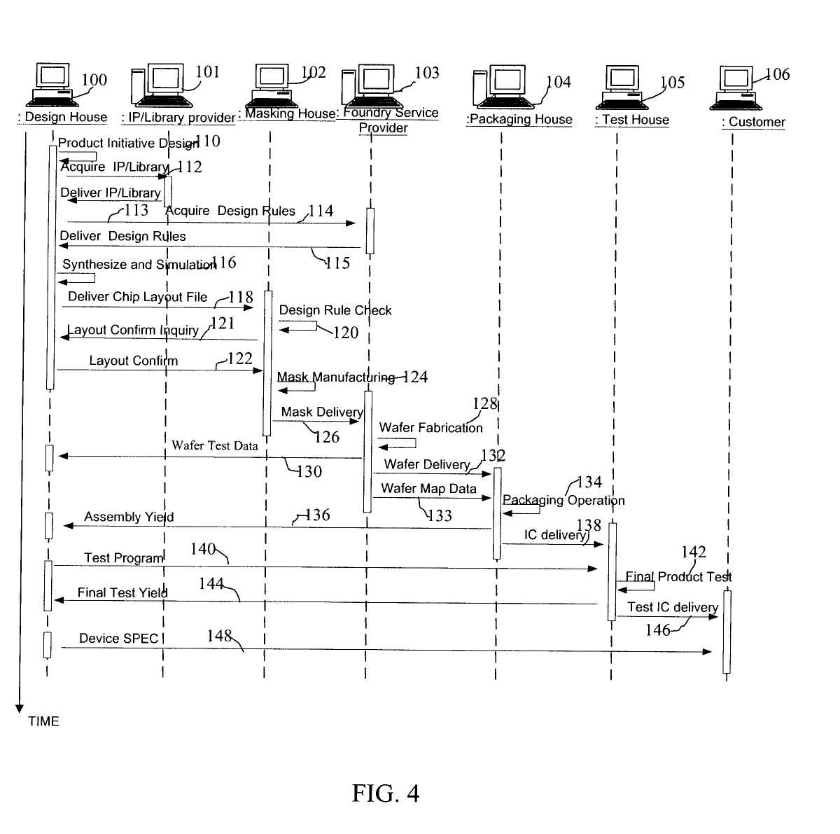

FIG. 2 is a more detailed block diagram of an embodiment of system 10 for engineering chain management. As described above, system 10 comprises design function 12, IP library function 14, mask preparation function 16, manufacturing execution function 18, and assembly/test function 20 having a predetermined framework for sharing data with one another over network 22. Each function may comprise three main components: a software tool or application, one or more engineering chain agents (ECA), and a web service interface. The software tool or application may provide a graphical user interface to receive user input, stored data and other information. The software tool or application may posses alternative functionality, such as the foundry service may comprise a manufacturing execution system (MES) application whereas the design service module may include a design management application. The engineering chain agent may be an intelligent agent object under a component-based framework operable to support applicable data types and formats, provide security, and provide reliable data exchange. The web service interface is operable to support transport and conversion of many data formats into web service formats. More details on the engineering chain agent are set forth below with reference to FIG. 4.

Design function 12 includes a design management application 30 that interfaces with the users or engineers at the design facility. Design management application 30 may be operable to oversee and control the device design process and may receive input from the users and display or otherwise output data to the users. Design management application 30 also interfaces with a plurality of engineering chain agents in the design function 12. The engineering chain agents may include an IP library engineering chain agent 32, a work-in-progress (WIP) engineering chain agent 34, a mask management engineering chain agent 36, a FAB/ASM/Test engineering chain agent 38, and a yield management engineering chain agent 40. IP library engineering chain agent 32 may be operable to interface with the IP library service function 40 or provider as well as the exchange of data therewith. WIP engineering chain agent 34 may be operable to manage and control the work flow of projects that are in the design progress. Mask management engineering chain agent 36 may be operable to interface with and manage the data exchange with a mask service function 16 or provider. FAB/ASM/Test engineering chain agent 38 may be operable to interface with and manage the data exchange with a foundry service function 18 or provider and an assembly/test service function 20 or provider. Yield management engineering chain agent 40 may be operable to determine and manage the product yield from the fabrication process. Details of the structure and function of an engineering chain agent object are set forth below with reference to FIG. 4. Engineering chain agents 32-40 in the design function 12 also provide an interface between design management application 30 and a web service interface 42.

IP library function 14 includes an IP library management application 44 that interfaces with the users or engineers at the IP library service provider. IP library management application 44 may be operable to manage the data content of the IP library and the access of the data. IP library management application 44 may also receive input from the users and display or otherwise output data to the users. IP library management application 44 also interfaces with a plurality of engineering chain agents in the IP library function 14. The engineering chain agents may include an IP library engineering chain agent 46, a patent engineering chain agent 48, a version engineering chain agent 50, a customer engineering chain agent 52, and a yield management engineering chain agent 54. IP library engineering chain agent 46 may be operable to control access to the IP library data. Patent engineering chain agent 48 may be operable to maintain and control data related to patent grants on the IP library components. Version engineering chain agent 50 may be operable to maintain version control of the IP library components. Customer engineering chain agent 52 may be operable to interface with and exchange data with the customers of the IP library service provider. Yield management engineering chain agent 54 may be operable to maintain yield data related to the IP library components. Engineering chain agents 46-54 in the IP library service function 14 also provide an interface between IP library management application 44 and a web service interface 56.

Mask preparation function 16 includes a mask preparation application 58 that interfaces with the users or engineers at the mask service provider. Mask preparation application 58 may be operable to assist in mask design and preparation and may receive input from the users and display or otherwise output data to the users. Mask preparation application 58 also interfaces with a plurality of engineering chain agents in the mask service function 16. The engineering chain agents may include a design rule checking (DRC) engineering chain agent 60, an optical proximity correction (OPC) engineering chain agent 62, a WIP engineering chain agent 64, a shop floor engineering chain agent 66, and a yield management engineering chain agent 68. Design rule checking (DRC) engineering chain agent 60 may be operable to interface and control the data exchange with the design rule checking process or software. Optical proximity correction (OPC) engineering chain agent 62 may be operable to interface and control the data exchange with the OPC process or software. WIP engineering chain agent 64 may be operable to provide an interface with the work-in-progress and control data access thereof. Shop floor engineering chain agent 66 may be operable to manage and control the data exchange with the shop floor. Yield management engineering chain agent 68 may be operable to determine and access data related to product yield data. Engineering chain agents 60-68 in the mask service function 16 also provide an interface between mask preparation application 58 and a web service interface 70.

Manufacturing execution function 18 includes a manufacturing execution system application 72 that interfaces with the users or engineers at the foundry manufacturing service function 18 or provider, or the manufacturing facility. Manufacturing execution system application 72 may be operable to support and manage the manufacturing process flow and may receive input from the users and display or otherwise output data to the users. Manufacturing execution system (MES) application 72 also interfaces with a plurality of engineering chain agents in the manufacturing execution function 18. The engineering chain agents may include a shop floor engineering chain agent 74, a WIP engineering chain agent 76, a scheduling engineering chain agent 78, an equipment engineering chain agent 80, and a yield management engineering chain agent 82. Shop floor engineering chain agent 74 may be operable to manage and control the data exchange with the shop floor. WIP engineering chain agent 76 may be operable to provide an interface with the work-in-progress and control data access thereof. Scheduling engineering chain agent 78 may be operable to provide data exchange with the manufacturing scheduling software and/or personnel. Equipment engineering chain agent 80 may be operable to provide support for the fabrication equipment and monitor their status. Yield management engineering chain agent 82 may be operable to determine and access data related to product yield data. Engineering chain agents 74-82 in the manufacturing execution function 18 may also provide an interface between manufacturing execution system application 72 and a web service interface 84.

Assembly/test function 20 includes an assembly/test application 86 that interfaces with the users or engineers at the product assembly and test service provider. Assembly/test application 86 may receive input from the users and display or otherwise output data to the users. Assembly/test application 86 also interfaces with a plurality of engineering chain agents in the Assembly/test function 20. The engineering chain agents may include a shop floor engineering chain agent 88, a WIP engineering chain agent 90, an assembly engineering chain agent 92, a test engineering chain agent 94, and a yield management engineering chain agent 96. Shop floor engineering chain agent 88, a WIP engineering chain agent 90, an assembly engineering chain agent 92, a test engineering chain agent 94, and a yield management engineering chain agent 96. Shop floor engineering chain agent 88 may be operable to manage and control the data exchange with the shop floor. WIP engineering chain agent 90 may be operable to provide an interface with the work-in-progress and control data access thereof. Assembly engineering chain agent 92 may be operable to monitor and control the assembly process and provide data exchange therewith. Test engineering chain agent 94 may be operable to monitor and control the testing process and provide data exchange therewith. Yield management engineering chain agent 96 may be operable to determine and access data related to product yield data. Engineering chain agents 88-96 in the assembly/test function 20 also provide an interface between assembly/test application 86 and a web service interface 98.

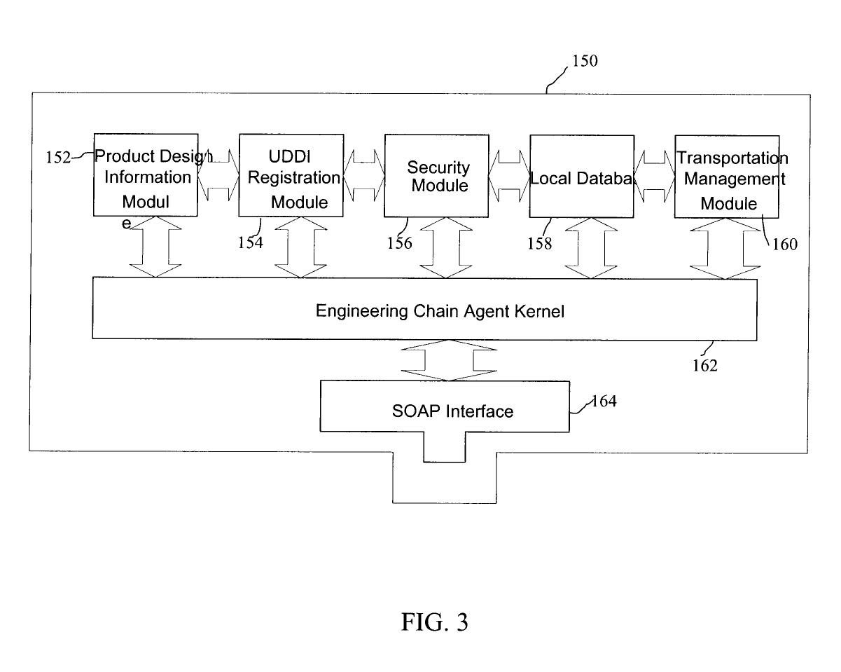

FIG. 3 is a simplified block diagram of an embodiment of an engineering chain agent 150. Engineering chain agent 150 may be a software intelligent agent object that may inherit properties and functions from existing electronic commerce management system (ECMS) components. ECMS is a generic system that can be used to support application development of electronic commerce systems.

Engineering chain agent 150 may have a product design information module 152 that is operable to support all data requirements such as data type, data format, and delivery schedule, for a new device design. Product design information module 152 may define and store an identifier for the product being designed and manufactured, and the company name to which the product belongs.

Engineering chain agent 150 may also include an UDDI registration module 154 which is operable to enable users to discover and register for web services and participate in the data exchange. UDDI registration module 154 may provide a description of basic service information and service functionality to registered users to request data from the service providers. UDDI registration module 154 may include user identifier and password data for UDDI data exchanges. UDDI is cited herein as an example of a framework for discovering and registering for web services.

Engineering chain agent 150 may also include a security module 156 that provides data and access security control measures. Security module 156 may support SSL (Secure Socket Layer), for example. Security module 156 may authorize and verify access privileges to the system to individuals and may also provide role-based access to system data. Security module 156 may also specify data encryption algorithms to encrypt data in transit.

Engineering chain agent 150 may include a local database module 158 that provides an interface to enterprise databases and other data such as manufacturing execution system, engineering equation solver, and yield data preparation and loading applications. Local database module 158 may include a data server name, port number, and service name of the database server, and the mechanism to send queries to the local database.

Engineering chain agent 150 may further include a transportation management module 160 that is operable to provide the functionality to support and reassure reliable data exchange for data requests in system 10. Transportation management module 160 may include specifications of transportation methods, acknowledgement mechanisms, and error notification methods, for example.

Engineering chain agent 150 also includes an engineering chain agent kernel 162. Agent kernel 162 may be generic light weight reusable code to which new features can be added in the form of components or modules 152-160, for example. Engineering chain agent kernel 162 is operable to receive information from, provided information to, and/or control modules 152-160. Engineering chain agent 150 also includes an interface module 164 to web services in a format such as SOAP that provides the conversion of data formats.

FIG. 4 is a data sequence flow diagram of an embodiment of a system and method for engineering chain management. Although the present disclosure set forth below are applicable to a general product design and manufacturing life cycle, FIG. 4 is directed more specifically to a semiconductor design and manufacturing engineering cycle. As shown, data is exchanged between a design house (design function) 100, an IP/library provider (IP library function) 101, a masking house (mask service function) 102, a foundry service provider 103 (manufacturing execution function), a packaging house 104, a test house (Assembly/test function) 105, and a customer 106. The data exchange is preferably electronically and may be in any suitable format and transported via any suitable protocol. At the start of the process, design house 100 generates a product initiative design 110. Product initiative design 110 is to kick off new IC design project and define IC functions. Design house 100 then sends a request 112 to IP/library provider 101 to acquire design library components, and IP/library provider 101 responds with an appropriate requested IP/library components 115. Design house 100 also sends a request 114 to foundry service provider 103 to acquire design rules. Foundry service provider 103 provides the design house 100 with the appropriate design rules 115 in response to the request. Design house 100 then performs synthesis and simulation 116 and generate data therefrom. Design house 100 also transmits a chip layout file 118 to masking house 102. Masking house 102 performs a design rule check 120 on the layout file 118 and sends a layout confirmation inquiry 121 back to design house 100. Design house 100 then transmits a layout confirmation 122 to masking house 102. Making house 102 makes the mask in step 124, and then delivers the mask(s) and associated data 126 to foundry service provider 103. Foundry service provider 103 uses the mask(s) to manufacture the wafer with the design thereon in step 128. The associated wafer test data 130 such as inline data, wafer acceptance testing (WAT) data, and chip probe (CP) yield data are transmitted to design house 100. Foundry service provider 103 also delivers the wafer 132 and wafer map data 133 to packaging house 104, which performs packaging operation 134 by cutting the fabricated wafers into individual chips and packaging them into semi-conductor integrated circuit chips. Packaging house 104 also transmits assembly yield data 136 to design house, and delivers the integrated circuit chips 138 to test house 105. Design house 100 transmits a test program 140 to test house to perform on the integrated circuit. Test house 105 performs the final product test 142 on the integrated circuit and transmits the final test yield data 144 to design house 100. Test house 105 then delivers the tested integrated circuit 146 to customer 105. Design house 100 also transmits the device specifications 148 to the customer.

It should be noted that FIG. 4 provides only one illustrative example of the data exchange sequence flow for the system and method of engineering chain management and that variations in the type of data exchanged, the timing of data exchange, the sequence of data exchange, etc. may be made to adapt to the particular product being designed and manufactured.

Although embodiments of the present disclosure have been described in detail, those skilled in the art should understand that they may make various changes, substitutions and alterations herein without departing from the spirit and scope of the present disclosure. Accordingly, all such changes, substitutions and alterations are intended to be included within the scope of the present disclosure as defined in the following claims. In the claims, means-plus-function clauses are intended to cover the structures described herein as performing the recited function and not only structural equivalents, but also equivalent structures.

What is claimed is:

1. A manufacturing management system comprising:
a plurality of management modules, each module operable to perform functions associated with a phase of a manufacturing cycle;
a plurality of engineering chain agents associated and communicating with each of the plurality of management modules and operable to perform specific functions related to data exchange between the plurality of management modules; and
a plurality of web service interface modules enabling the plurality of engineering chain agents to communicate with one another and exchange data across a computer network.

2. The system of claim 1, wherein the plurality of management modules comprise a design management application module.

3. The system of claim 1, wherein the plurality of management modules comprise a component library application module.

4. The system of claim 1, wherein the plurality of management application modules comprise a manufacturing management application module.

5. The system of claim 1, wherein the plurality of management modules comprise an assembly application module.

6. The system of claim 1, wherein the plurality of management modules comprise a test application module.

7. The system of claim 1, wherein the plurality of management modules comprise a mask preparation application module.

8. The system of claim 1, wherein the engineering chain agent comprises a product design information module having data associated with a product design identifier and a product design role.

9. The system of claim 1, wherein the engineering chain agent comprises a local database module having data associated with a server name, port number, and server identifier.

10. The system of claim 1, wherein the engineering chain agent comprises a security module having security mechanism for accessing and exchanging data.

11. The system of claim 1, wherein the engineering chain agent comprises a transport management module having data associated with transport method, and mechanism for handling data exchange error.

12. The system of claim 1, wherein the engineering chain agent comprises a web services discovery and registration module.

13. The system of claim 1, wherein the engineering chain agent comprises a web service interface operable to convert to and from at least one web services data format.

14. A method for managing a product development life cycle, comprising:
providing, a product design unit, a remote communication interface with a plurality of product service providers;
enabling an exchange of product-related data between the product design unit and the plurality of product service providers through the remote communication interface; and
managing the exchange of product-related data between the product design unit and the plurality of product service providers.

15. The method of claim 14, wherein providing a remote communication interface comprises exchanging data via web services over the Internet.

16. The method of claim 14, wherein providing a remote communication interface comprises providing a wireless communication interface.

17. The method of claim 14, wherein enabling an exchange of product-related data comprises enabling an exchange of product design data, component library data, and test data.

18. The method of claim 14, wherein enabling an exchange of product-related data comprises enabling an exchange of product design data, IP library data, design rules, chip layout data, mask data, test data, and yield data.

19. The method of claim 14, wherein providing a product design unit an electronic communication interface with a plurality of product service providers comprises providing an electronic communication interface with a component library provider, a test service provider, and a manufacturer.

20. The method of claim 14, wherein providing a product design unit an electronic communication interface with a plurality of product service providers comprises providing an electronic communication interface with an IP library service provider, a mask house, a foundry, an assembly/test service provider, an assembly service provider, and a test service provider.

21. The method of claim 14, further comprising authenticating parties involved in any data exchange.

22. The method of claim 14, further comprising preventing access to system data by authorized parties.

23. The method of claim 14, further comprising encrypting the product-related data prior to exchanging the product-related data.

24. A software agent comprising:
a product design information module operable to manage data exchange related to a product;
a security module operable to control access to data;
a local database module operable to control and manage access to local data;
a web service module operable to provide registration to web service data exchange among the product designer and the plurality of service providers;
a web service interface module operable to convert data to and from at least one web service data format and provide data exchange among a product designer and a plurality of service providers; and
a transport management module operable to provide reliable data exchange between the product designer and the plurality of service providers.

25. The software agent of claim 24, further comprising a generic kernel.

26. The software agent of claim 24, wherein the modules operate with a design management application.

27. The software agent of claim 24, wherein the modules operate with a manufacturing execution system application.

28. The software agent of claim 24, wherein the modules operate with an IP library management application.

29. The software agent of claim 24, wherein the modules operate with an assembly/test application.

30. The software agent of claim 24, wherein the modules operate with a mask preparation application.
